(19) United States
(12) Patent Application Publication
(10) Pub. No.: US 2005/0078090 A1
(43) Pub. Date: Apr. 14, 2005

(54) Method and apparatus for indicating available input options of electronic terminal devices

(76) Inventors: Hans-Mathias Glatzer, Castrop-Rauxel (DE); Amir Imam, Muhlheim a.d. Ruhr (DE); Jens-Uwe Soehner, Dortmund (DE); Reza Serafat, Bochum (DE)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/499,782

(22) PCT Filed: Dec. 19, 2001
(86) PCT No.: PCT/EP01/15038

(51) Int. Cl. G09G 5/00

(52) U.S. Cl. 345/168

(57) ABSTRACT

The present invention relates to a method and an apparatus for indicating available input options of electronic terminal devices by selectively highlighting active inputting means. An electronic terminal device according to one aspect of the invention is able to indicating available input options. Such a terminal device comprises a plurality of user inputting means for inputting a user input, means for highlighting at least one of said inputting means, and means for operating said highlighting means according to said available input options. A device according to the invention can show the user in an input means is available to prevent invalid and frustrating user input.

The present invention relates to method and an apparatus to provide a fast and simple way to indicate different functions of a keyboard according to applications running on a terminal device. It also relates to providing an input selection through an inputting device that has localized lighting near user actuated inputting means. This invention relates to providing a graphical user interface, and more particularly to providing input selection through an input device that has localized lighting near pressure actuated input surfaces. And most specifically the color of said lighting is associated with a color highlight appearing at a display. More specifically the invention relates to a simple way to operate a terminal device with a minimized requirement to use handbooks and manuals.

Program control of a CPU, e.g. a personal computer, is frequently driven by user inputs via a keyboard or other discrete input device. A key, sometimes called a button, or keypad, often has a preprinted character, e.g. a number, a letter or a symbol appearing on it. This provides a user with an understanding of a function that the key is generally supposed to trigger.

The need for bigger keyboards for smaller mobile terminal devices is growing all the time when mobile terminal devices get smarter. At the same time the size of the mobile terminal devices have to remain small or be even smaller than today. On possible solution is to include multi-function keys in keyboards with buttons like “2^{nd}”, “Strg”, “Alt”, “Alt Gr”, and the like. A function of a key may vary according to the state of the CPU, also known as the context of the CPU. For example, pushing a key denoted as ‘Caps Lock’ on its surface, will trigger a toggling of a QWERTY keyboard between lower-case and upper-case keyboard input. Similarly, use of the ‘function’ key or ‘control’ key on modern personal computers causes keys to take on a myriad of functional abilities, depending on the program operating on the Personal Computer or PC. One of the problems arising of such multiple function keyboards is, that an average user needs to study the handbook or a manual to recognize the usually rarely used functions. In some cases of controlling a CPU, it is unnecessary to mark a key with any symbolic notation to indicate its purpose.

The computer device can comprise a graphical user interface with functional text, or functional graphics. A graphic function may cause any process or execution of any device operatively coupled to the CPU of the computer device. A functional text, or a graphic as in graphical interfaces may appear anywhere on a display. More importantly, in a desktop environment, keys are so far from the display, that even if functional text or graphics were located at the periphery of the display, an average user might find it difficult to see a correlation between keys on a keyboard and displayed text or graphics.

Fortunately, many techniques for using pointing devices remove the need for such an arrangement. Even before mice were available, menus provided similar ability to call on functions. A menu, or submenu item, would have a precursor number, or letter, set apart from, or highlight within, functional text. A typical menu, once displayed, is operated in tandem with an input routine that permits a selection upon the occurrence of a single keystroke, wherein the selected function is denoted by the functional text of the menu item, and the operating key, by a single highlighted symbol therein.

In a situation of handheld computers, sometimes embedded in mobile stations, such as mobile phones, the menu keys are known as soft-keys. These soft-keys are mounted very close to a display surface, e.g. about ¼ inch. In contrast to a typical laptop—the nearest keys on an IBM® ThinkPad are about 1¼ inch away from a display surface. Even though the mobile station has a minimal distance, many people are unable to make the connection between the softkey and the intended function displayed nearby. The description of the functions has even been provided imprinted on masks of carton or plastic sheet which are to be placed over the keyboard. Additionally menu masks are not suitable for keys with no space between the single keys. In such instances, much of the functionality of the mobile phone is hidden from the person using the phone.

Because a mobile station is used frequently as a personal communication device, it has versatility not present in wired phones. Consequently, the mobile station has been designed for use in all manner of conditions, including darkness. Thus the keypads are often designed to illuminate from within when entries are being made. Because the purpose has been to improve visibility of keys, the lighting is usually uniform to all keys, and has been monochromatic.

Since a hand-held unit, and in particular a mobile phone, must devote space for a 12-key keypad, the room allowed for a display is frequently small, e.g. about 5-6 lines of text. Although a mouse of diminutive proportions could be added using a J-key sensor, fine cursor movement through such a small screen would yield markedly diminished results as compared to use with desktop sized monitors. None-the-less, requiring a user to use a cursor advance function, such as employed by the use of the ‘tab’ key in the popular text browser, LYNX, is inefficient, particularly as the operable choices start to exceed four. This becomes more taxing on the user of a device when a keypad has key-sizes less than a quarter of the area of the DIN-standard form factor of computer keyboards.

Other efforts have lead to touch screen displays. The average touch screen display can be adapted to different key sizes. Touch screen displays can provide written descriptions of the function of touch sensitive areas on the display. And the touch screen displays can even include graphic elements to describe the functions. Touch screen displays have the main drawback that their substantially transparent surface do not allow to provide a touch screen display with palpable structures to use it “blind”.

Hence, a need exists for a selection method and apparatus to reduce repetitive keystrokes on mobile terminal devices that provide graphic representations of commands visible on a display. A need exists to form a visible link between a key on a keypad and a graphic representation of a command on a screen without crowding keys around the display. An ability to obtain greater functionality from a standard key layout is also needed. It is further desirable to have a device and a method to enable a user to recognize which input function or which key is actually active and useable.

The present invention provides a method and apparatus for selecting a function in a mobile input device. Highlighting the available keys of a current application can improve usability of the device. For example, a game application can highlight the required navigation keys as well as any other keys for specific game action. Same procedure can be applied for other applications, which use limited number of keys on the keypad. Highlighting the active keys makes even more sense, when a user defines his own keys for certain actions in an application. The highliting operation may be operated by the application itself, or the CPU branches program execution to relate the graphic user interface elements and keys as a function based on the active selection. To simplify the access of the second functions, the keyboard may guide the user by highlighting operable keys in accordance with pressed functions keys or running applications.

According to an aspect of the present invention, there is provided an electronic terminal device able to indicate available or expected input options. The terminal device comprises a plurality of inputting means for user selected input, means for highlighting at least one of said inputting means, and means for operating said highlighting means in accordance with currently available or expected user input. Such a device can e.g. be a simple plug on- or pug in keyboard e.g. for a mobile telephone. Such a keyboard can comprise a number of LED or a single LED and lightguides to illuminate secondary input options. The keyboard may comprise “second function”-keys as “Strg”, “Alt” and the like as known from a computer keyboard to illuminate e.g. all keys available together with said second function key. The keyboard may comprise e.g. a switching device as a wiper switch to activate and illuminate certain predefined input keys forming e.g. a gamepad. The keyboard can comprise a bi-directional interface to receive commands to illuminate certain keys or inputting means.

Preferably, said electronic terminal device further comprises a processing means capable of executing an application, and means for operating said highlighting means in accordance with currently available or expected user input provided by said application. Said application can be e.g. a software program. Such a device comprises e.g. a keyboard, a touchpad, a voice recognition means with a microphone and the like as inputting means. The device further comprises an application running on said processing means, activating e.g. the voice recognition by a key input and the device illuminates the microphone to indicate that the voice input is activated. The electronic terminal device can be e.g. a telephone answering machine, highlighting the keys and the microphone in the sequence required to record an answering text. With a processing means, a keyboard according to an embodiment of the invention may be connected via a bi-directional serial and maybe wireless interface to a computing device. The illumination means can be implemented in the keyboard to illuminate the keys, an area surrounding the keys. The illumination means may be located remote from the keyboard to illuminate the keys e.g. by means of one or more laser diode and a mirror or lightguide system. The laser diode may be connected to a keyless keyboard observing the motion of the fingers of a user to indicate the place the user expects the virtual key. Alternatively the highlighting function can be provided, e.g. by a shutter goggle worn by the user to superpose the virtual illumination with the environmental vision of the user.

Advantageously, said electronic terminal device further comprises a displaying means. The displaying means can be a small liquid crystal display (LCD) located e.g. on a keyboard to inform a user about an activated mode, can be video monitor of a video telephone, or the like.

Conveniently, said highlighting means are located or operated, according to said input options. The highlighting means can comprise a single highlighting means for each inputting means, so that e.g. a software may activate every highlighting means independently. The highlighting means can only be located at certain inputting elements to illuminate only a few pre-selected keys, to reduce the number of required highlighting means to reduce the costs. The illuminated keys can be arranged in a way that a user can recognize the function of the keys from their mutual position of arrangement.

Preferably, the said highlighting means can emit light of different colors to provide different colors of said inputting means. This may be realized by multi color LEDs, or at least two LEDs of different color beneath the keys. The illumination means may further comprise a test mode, wherein all illumination means can be operated to detect failures in the illumination option.

Conveniently, said inputting means are semi transparent. Semi transparent inputting means offer the option not only to illuminate the inputting means, but to transmit light trough said inputting means. Such a feature can be used e.g. to use transparent keys with e.g. a surface contour depicting a first character in an un-illuminated state and a lightsource projecting a second different character on the surface in the illuminated state. This may be combined with multiple light sources projecting multiple different characters on the surface of one key.

According to another embodiment of the present invention there is provided an electronic terminal device for indicating available input options. Said terminal device comprises at least two different colored inputting means for user selected input, a color display, e.g. a color LCD, a processing means capable of executing an application, and means for operating said displaying means in accordance with currently available or expected user input provided by said application means for operating said displaying means in accordance with currently available or expected user input provided by said application.

So the displaying means can be operated in accordance with currently available or operable colored inputting means. This is a new concept of a color related menu key concept, enabling even alliterate persons to use applications of electronic terminal devices. This embodiment represents the inversion of the idea to illuminate the keys of an electronic terminal device according to the color of available or displayed input option. So the keyboard or keypad is pre-colored and the display color is changed to invert the menu principle.

Advantageously, said electronic terminal device is a keyboard. This can be an especially useful embodiment of the invention for training and educational purposes, wherein with the activation of a second function mode of the keyboard all available keys are illuminated. Such a preview option enables the user to recognize available keys and can prevent e.g. invalid input.

Conveniently, said terminal device is a mobile electronic terminal device or a telephone. As mobile terminals are getting smarter, the phones become more and more electronic versatile devices including more and more different functions and therefore require more and more different inputting means. To reduce the number of inputting means in smaller phones, the mobile terminal devices require more and more versatile inputting means. This can be provided by keyboards with different highlighting patterns for different input options or input modes which can be recognized by users.

According to another aspect of the present invention, there is a method provided for indicating available inputting means of an electronic terminal device. The method is executed by detecting an available, expected or executed user input of said terminal device, and selectively highlighting said inputting means according to said detected input. The activated illumination means indicate available inputting means by selectively highlighting available inputting means. This method is simple to operate e.g. the illumination function of a keyboard by illumination e.g. by selectively illuminating a keypad within a qwerty-keyboard to operate a numeral keypad for one hand numeral input. The terminal device can be a terminal device as described above having a plurality of inputting means for inputting user input, means for highlighting at least one of said inputting means, and means for operating said highlighting means according to said available input options.

Preferably, said method for indicating available input options of an electronic terminal device further comprises detecting available or expected input options provided by said application. This method offers the option to use a single keyboard with different input options, which are indicated by the software controlled device. A electronic terminal device can be e.g a mobile terminal device and therefore e.g. comprise a plurality of inputting means for inputting user input, means for highlighting at least one of said inputting means, and means for operating said highlighting means according to said available input options, a processing means to execute an application e.g. a computer program and means for operating said highlighting means according to available input options provided by said application.

Advantageously, said available input options are dependent from a current user input. The current user input can be e.g. a pressed “Strg.”, “Alt.” or other function key.

Conveniently, the method further comprises displaying available or expected input options on a display. This option helps the user to recognize a correspondence input option visible on the display and highlighted on the keyboard. If the color of the depicted input option and the color of the color on the keyboard is the same a user can simply recognize a logic connection between the display and the keyboard.

Preferably, said displayed input options on the display are depicted in the same color said highlighting means illuminate said available inputting means. The color relation helps to simplify the recognition of the relation between the graphic inputting means and said key combination.

Preferably, said depicted input options are displayed in the same way said inputting means are highlighted. So the same color on the display is used for highlighting said available inputting means. The color relation helps to simplify the recognition of the relation between the graphic inputting means and said key combination. This feature is enables a mobile telephone to flash the illumination of a key and to flash a depicted icon, to underline e.g. a required user input, or the logic connection between an icon and a respective key.

Another advantage provided by one or more embodiments is that on a device controllable chiefly with buttons, a method is provided that permits selection of any listed item with a single keystroke, without the need to find a matching symbol to the listed item on a button. An advantage provided by one or more embodiments of the invention is that highlighted portions of a display, and any corresponding function, may be selected by inputting a unique color associated with the function. This may be done with a single keystroke, even though there may be many choices visible on the screen.

Advantageously, said illumination means is used to illuminate said inputting means in a certain sequence to train a user training. This can be combined e.g. with a “help”-file wherein said input “recipe” is indicated as a sequence of illuminated keys. The sequence can be indicated e.g. by a color, an intensity, or an intensity modulation. This method can be used to visualize the available inputting means to play e.g. a “jump and run”- or adventure game or to move e.g. the visual area of a virtual screen.

According to another embodiment of the present invention, a method for indicating available or expected input options comprises the steps of, detecting an operational state of said application and detecting available or expected input options, of said colored inputting means, selectively operating said display according to said detected input options. This embodiment represents the inversion of the idea to illuminate the keys of an electronic terminal device according to the color of available or displayed input option. So the keyboard or keypad is pre-colored and the display color is changed to invert the menu principle.

According to another aspect of the present invention, a software tool for carrying out the method for indicating available input options in an electronic terminal device is provided, which comprises program code means for performing all of the steps of the methods described above when said software tool is run on an electronic terminal device.

According to another aspect of the present invention, a computer program for carrying out the method for indicating available input options in an electronic terminal device is provided, which comprises program code means for performing all of the steps of the methods described above when said program is run on an electronic terminal device such as a mobile telephone.

According to another aspect of the present invention, a computer program product for carrying out the method for indicating available input options in an electronic terminal device is provided, which comprises program code means for performing all of the steps of the methods described above when said computer program product is run on an electronic terminal device such as a mobile versatile device.

In the following, the invention will be described in detail by referring to the enclosed drawings in which:

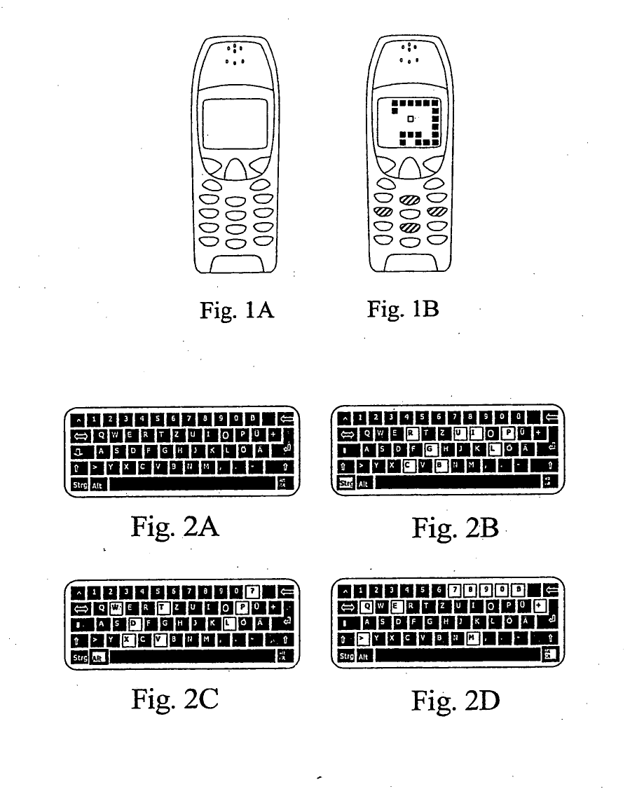

FIGS. 1A and 1B show a mobile telephone according to an embodiment of the present invention depicted in two different input modes,

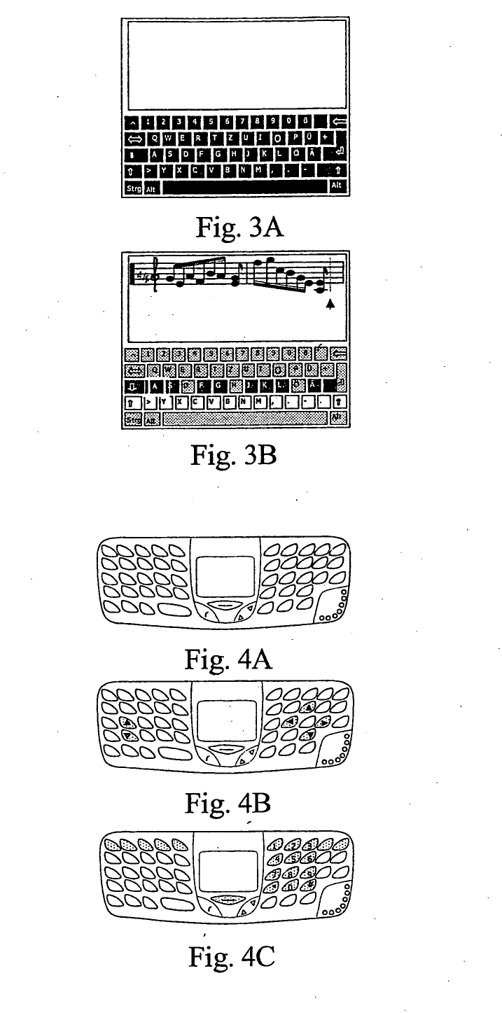

FIGS. 2A to 2D show a keyboard according to another embodiment of the present invention in depicted in four different input modes,

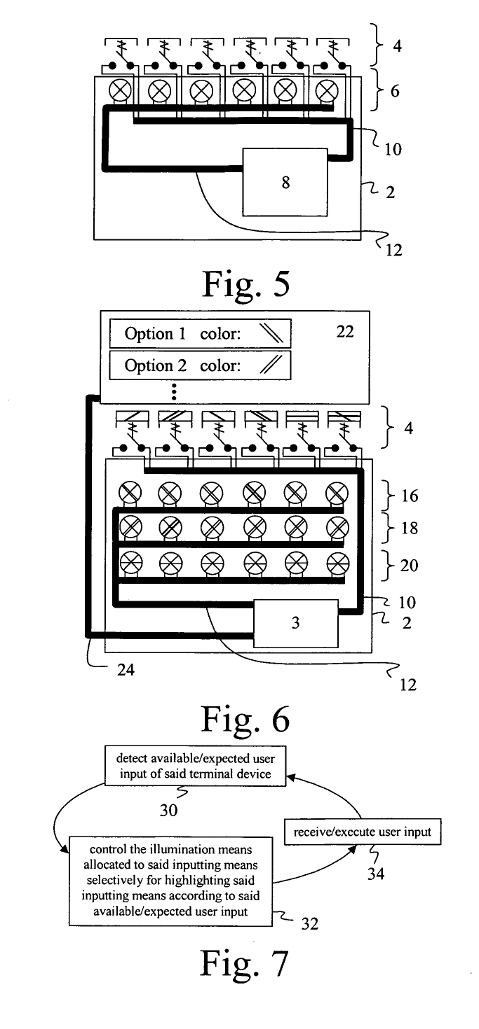

FIGS. 3A and 3B show a mobile personal digital assistant (PDA) according to another embodiment of the present invention with a keyboard in two different input modes,

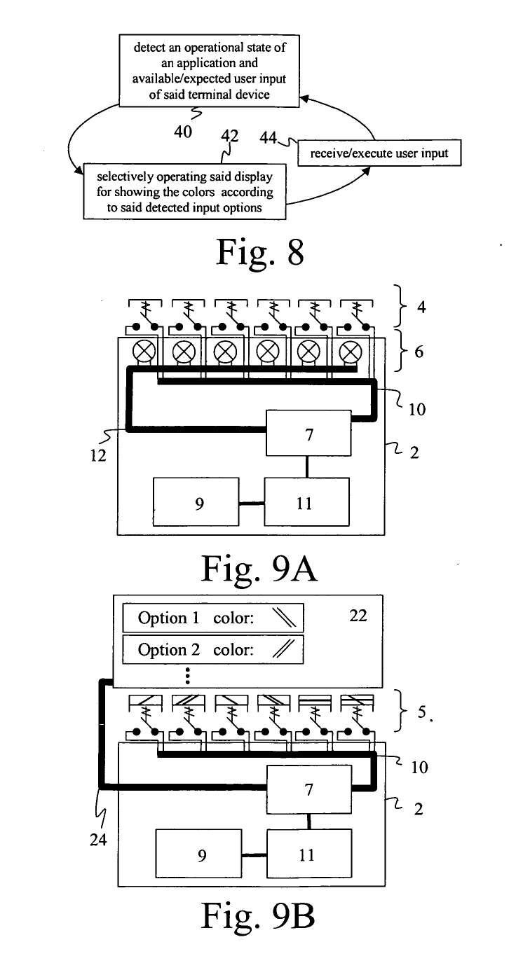

FIGS. 4A to 4C show a mobile smartphone with a qwerty-keyboard according to another embodiment of the present invention depicted in three different input modes.

FIGS. 1A shows a conventional mobile telephone with an un-illuminated keyboard. In FIG. 1B there is a gaming application activated on the mobile telephone. The activated game is called “snake” and can be operated by 4 keys to direct the snake on the display. In the activated application, only the four keys “2”, “4”, “6”, and “8” are active and available. During the playing game (e.g. snake) or running another application the active keys (as shown below for navigation keys in a game application) are highlighted/illuminated for usability improvement.

FIGS. 2A to 2D show a keyboard according to another embodiment of the present invention. FIG. 2A depicts a conventional qwerty-keyboard of e.g. a computer or a terminal device in a conventional “all active” key mode. The keyboard comprises illumination means and is able to illuminate each of its keys independently. As in the case of conventional keyboards the depicted keyboard comprises second functions keys as “STRG”, “ALT” and “ALT GR”.

In FIG. 1B the second function key “STRG” is pressed and depicted bold outlined, some of the keys of the keyboard can be used to start operations. But not all keys have second functions. To show a user which key, has a second function and can be operated the available keys are illuminated. In the present example the keys “R”, “L”, “G”, “C”, “P”, “U”, “I”, and “B” are illuminated and provide the functions “right-aligned”, “left-aligned”, “grouped style”, “copy”, “paste”, “underlined”, and “bold”. It should be noted that available keys may be un-illuminated and the unavailable keys are illuminated, and the illumination is used to enable a user to distinguish between available and unavailable input keys.

In FIG. 2C the second function key “ALT” is pressed, some of the keys of the keyboard can be used to start operations. But not all keys have second functions together with “ALT”. To indicate to a user which key has a second function and can be operated the available keys are illuminated. In the present example the keys “?”,“T”, “W”, “V”, “D”, “L”, “X”, and “P” are illuminated and provide the functions “help”, “format”, “view”, “data”, “table”, “extra” and “process”.

In FIG. 1D the second function key “ALT GR” is pressed, some of the keys of the keyboard can be used to start operations. But not all keys have second functions together with “ALT GR”. To show a user which key has a second function and can be operated the available keys are illuminated. In the present example the keys “7”,“8”, “9” “0”, “?”, “Q”, “E”, “+”, “>” and “M” are illuminated and provide the characters “{”, “[”, “]”, “}”, “\”, “@”, “ε”, “˜”, “|” and “μ”, as in the case of conventional qwerty-computer keyboards.

The specific keys of a device keypad can be highlighted by the application itself. The highlighting of the keys may be operated e.g. by a custom programmed computer device located in the keyboard. For example, by separate or additional illumination of the relevant keys. In this way, the activated keys are distinguished from inactive keys, to improve the usability of the device.

It is to be noted that special function keys may be activated only with a combination of pressed second function keys as “STR” and “ALT”. Keys activated with such a key combination pressed may be highlighted with a different color to prevent confusion of the user. There are a lot of keys on messaging devices, so from usability point of view, it is easier for the user to find application relevant keys when they are highlighted in a special way, e.g. by flashing illumination or by two changing the color with a certain frequency.

FIGS. 3A and 3B show a mobile personal digital assistant (PDA) according to another embodiment of the present invention with a keyboard in two different input modes.

As in the above described figures, the first FIG. 3A depicts an electronic terminal device in an un-illuminated state. The depicted device is a PDA or a mobile communicator with a display and a keyboard.

In FIG. 3B, the qwerty-keyboard is illuminated with two different colors. The keys illuminated gray are inactive, and the un-illuminated and pale illuminated keys are active. The white and gray keys form a piano keyboard or an organ manual and are to offer a music editor option to a user. This option enables a user to simply edit and generate sounds with the mobile terminal device, to generate e.g. an unique telephone call sound or melody. The user can simply recognize the function provided by a simple qwerty keyboard. Any other qwerty-keyboard music input option would be less intuitive, and simple to use.

FIGS. 4A to 4C show an embodiment of the present invention depicting a mobile smartphone with a qwerty-keyboard in three different input modes.

As in the above described figures, the first FIG. 4A depicts a mobile terminal device, a mobile smartphone with a qwerty-keyboard in an un-illuminated state. The depicted phone/keyboard combination can be used to generate and edit short messages (SM) or e-mails.

FIG. 4B depicts the same smartphone in a gaming mode with four keys illuminated for directing a game object with the right thumb, and illuminated two keys illuminated on the left side for operating different game related actions as known from conventional gamepads of video games.

FIG. 4C depicts the same phone/keyboard combination in a telephone mode with an illuminated U.I.T.-keyboard to be operated with the right thumb, as the numeral keys of the querty-keyboard are hard to operate and require two hand operation. For illumination of the keys, small LEDs for each key can be built in the keypad, which are activated by the application.

One advantage provided by one or more embodiments is that recognition of a linkage between a button and a displayed function is improved so that people who are illiterate may still see the connection between a distant button and a displayed graphic command depiction having a color in common with the button. Moreover, persons with moderate sight impairment may better locate buttons having color from edge-to-edge, than locate one of several characters that appear on a button face.

Another advantage provided by one or more embodiments is that there is no difficulty reading button colors, even though a device may be oriented upside down, with respect to characters printed on buttons.

Another advantage provided by one or more embodiments is that the display, though it may be too full of graphic command elements to see a positional correlation with nearby buttons, is still close enough to the buttons, that the button colors may be seen with peripheral vision. This permits a button selection that is accurate in terms of selecting the matching command depiction-while never glancing away from the display.

This application contains the description of implementations and embodiments of the present invention with the help of examples. It will be appreciated by a person skilled in the art that the present invention is not restricted to details of the embodiments presented above, and that the invention can also be implemented in another form without deviating from the characteristics of the invention. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

1. An electronic terminal device for indicating available input options comprising:
a plurality of inputting means for user selected input,
means for highlighting at least one of said inputting means, and
means for operating said highlighting means in accordance with currently available or expected user input.

2. An electronic terminal device according to claim 1, further comprising:
processing means capable of executing an application,
means for operating said highlighting means in accordance with currently available or expected user input provided by said application.

3. An electronic terminal device according to claim 1, further comprising displaying means.

4. An electronic terminal device according to claim 1, wherein said highlighting means provide different colors of said inputting means.

5. An electronic terminal device according to claim 1, wherein said inputting means are semi-transparent.

6. An electronic terminal device for indicating available input options comprising:
a plurality of differently colored inputting means for user selected input,
displaying means capable of displaying different colors on a display,
processing means capable of executing an application, and
means for operating said displaying means in accordance with currently available or expected user input provided by said application.

7. An electronic terminal device according to claim 6, wherein said electronic terminal device is a keyboard.

8. An electronic terminal device according to claim 6, wherein said terminal device is a mobile electronic device or a mobile telephone.

9. A method for indicating available or expected input options of an electronic terminal device having inputting means, by the steps of:
detecting an available or expected user input of said terminal device, and
selectively highlighting said inputting means according to said detected input.

10. A method according to claim 9, wherein an application is running on said electronic terminal device, further comprising the step of:
detecting available or expected input options provided by said application.

11. A method according to claim 9, wherein said available input options are dependent from a current user input.

12. A method according to claim 9, further comprising displaying available or expected input options on a display.

13. A method according to claim 12, wherein said displayed input options are displayed on said display the same way said inputting means are highlighted.

14. A method according to claim 10, wherein said highlighting means is used to illuminate a sequence of inputting means for user training.

15. A method for indicating available or expected input options of an electronic terminal device having colored inputting means, a display having differently operable colors and an application running on said terminal device, comprising the steps of:
detecting an operational state of said application and detecting available or expected input options, of said colored inputting means, and
selectively operating the colors of said display according to said detected input options.

16. A software tool for executing said method for indicating available input options in an electronic terminal device, comprising program code means for carrying out the steps of claim 9 when said program is run on a terminal device.

17. A computer program for executing said method for indicating available input options in an electronic terminal device, comprising program code means for carrying out the steps of claim 9 when said program is run on a terminal device.

18. A computer program product comprising program code means stored on a computer readable medium for carrying out the method of claim 9 when said program product is run on an electronic terminal device.
